(19) United States
(12) Patent Application Publication
(10) Pub. No.: US 2013/0014692 A1
(43) Pub. Date: Jan. 17, 2013

(54) BIRD REPELLER

(71) Applicant: Jung Mi Lee, Yongin City (KR)

(72) Inventor: Jung Mi Lee, Yongin City (KR)

(21) Appl. No.: 13/636,619

(22) PCT Filed: Mar. 18, 2011
(86) PCT No.: PCT/KR2011/001870

§ 371 Date: Sep. 21, 2012

(30) Foreign Application Priority Data
Mar. 22, 2010 (KR) 10-2010-0025028

(51) Int. Cl. A01M 29/16

(52) U.S. Cl. 116/22 A

(57) ABSTRACT

A bird repeller is provided to prevent birds from approaching a utility pole and building their nests on the utility pole, the apparatus comprising: a solar cell; a fixing frame for fixing and installing the same; a flexible fixture which is elastically inserted and installed between cross arms; a wing means operated by the solar cell; a bird detecting sensor which is able to recognize approach of the birds; a noise generator and a sound wave generator which generate noises and sound waves which the birds dislike; and LED light emitters for emitting light which the birds dislike, whereby the bird repeller prevents fowl and other birds from building their nests between the cross arms provided on an upper part of the utility pole so that no wires are short-circuited and no other damage is generated.

### FIELD OF INVENTION

The present invention relates, in general, to a bird repeller for preventing birds from approaching a utility pole and nesting on the utility pole, and more particularly, to a bird repeller which is installed in a fixing frame such as cross arms provided at an upper end of the utility pole, and has a generation system capable of generating solar light energy to install a bird detecting sensor for detecting the movement of birds around the utility pole, and a movement means or noise and sound wave generators for preventing birds from approaching, thereby preventing the birds from approaching, whereby the bird repeller prevents fowl and other birds from building their nests between the cross arms provided at the upper end of the utility pole so that no wires are short-circuited and no other damage is generated.

### BACKGROUND ART

In general, to supply high-tension currents from a generation plant to customers including a factory and the like, high-tension lines are connected and installed along a geographical space over a considerable long distance. However, since the high-tension lines are very heavy, utility poles are installed at regular intervals so that while the high-tension lines do not sag, they are connected and install throughout the long distance. Furthermore, frames such as cross arms are installed on upper ends of the utility poles, and an insulator and an installation frame which are mediums for connecting the high-tension lines are provided in the cross arms, thereby connecting and using the high-tension lines.

At this time, a certain space is formed between the cross arms in which the insulator and the installation frame and the like are installed. There is a case in which small animals such as birds or the squirrel Sciurus vulgaris coreae build their nests in the space.

However, when the aforesaid small animals such as the birds or Sciurus vulgaris coreae construct their nests, there is a case in which they build their nests using long pieces of wire and the like rather than using only broken branches. Due to this, the high-tension lines are short-circuited to each other, so various electrical accidents such as short circuits or power outages occur, thereby generating considerable social and economical damage.

Accordingly, conventional apparatuses such as a pinwheel or a rotary plate for preventing the small animals or the birds such as magpies from approaching so as to prevent them from making their nests have been very variously installed and utilized at the upper end of the utility pole.

### DISCLOSURE

### Technical Problem

However, the conventional prevention apparatuses as above are apparatuses which move by external forces, namely, the wind or a rotating bearing and the like. It is problematic that these apparatuses cannot show their availability in the long term since they do not show their functions at their best in the cases where there is no wind, or they become rusty or have operation failure as a long time passes.

Accordingly, the present invention has been made keeping in mind the above problems occurring in the related art, and is intended to provide a device for repelling birds which discharges strong light using solar thermal energy in order to prevent the birds from approaching and nesting on a utility pole, thereby preventing various kinds of electric appliances and wire installed on the utility pole from being damaged or polluted due to the birds, and preventing the cause of a power outage accident caused by a metallic nest.

Furthermore, the present invention serves to provide a bird repeller which is configured such that a bird detecting sensor detects approach of the birds and enables sound waves or noises for driving away the birds to be generated only when the birds approach, thereby being capable of minimizing the consumption of electric power, and electric power is supplied using a solar cell, thereby being capable of saving energy, so it is cheap and easy to install.

### Technical Solution

In an aspect, the present invention provides a bird repeller which may be fixedly installed in cross arms of a utility pole to which high-tension lines are connected and installed, so as to prevent the birds from approaching.

The bird repeller may includes: a solar cell which converts solar light energy to electrical energy; a fixing frame which is adopted to fixedly install the solar cell; a flexible fixture which is provided in a lower side of the fixing frame and is elastically inserted and installed between the cross arms so that it can be fixed; a wing means which is provided on both sides of the fixing frame and is able to flutter up and down or right and left by the solar cell; a bird detecting sensor which is provided on an upper side of the fixing frame and is able to recognize approach of the birds; a noise generator and a sound wave generator which generate noises and sound waves which the birds dislike by operation of the bird detecting sensor; and a plurality of LED light emitters which are connected to the solar cell and emit light which the birds dislike so as to prevent the birds from approaching.

### Advantageous Effects

The bird repeller according to the present invention is fixedly installed on the side surface of the utility pole using fixing parts, and includes: the solar cell which receives solar light and converts it to electrical energy; a bird detecting sensor which is operated by the electrical energy converted from the solar cell and detects the approach of the birds around the utility pole; the noise and sound generators which are operated by receiving signals from the bird detecting sensor; and the movement means which is installed to rotate up and down or right and left and dries away the birds.

Furthermore, the bird repeller is configured such that when the birds approach, the bird detecting sensor for detecting the approaching birds and enables noises or sound waves to be generated, and the permanent magnet and the electromagnet using solar energy are operated so that the movement means moves or the LED light emitters emit the light, thereby preventing the birds from approaching, and as a result of this, preventing the electric appliances and the wires from being damaged or polluted by the birds and preventing the cause of a power outage accident due to metallic nests. Furthermore, since by detecting the approach of the birds with the bird detecting sensor detects, the sound wave and noise generators can be operated only when the birds approach, thereby being capable of reducing the consumption of power, and since energy is supplied using the solar cell, a separate component for the power supply is not, required so the bird repeller can be simply installed and can efficiently and environmentally repel the birds so that the birds are not damaged.

### DESCRIPTION OF DRAWINGS

FIG. 1 is a rough perspective view showing a state in which a bird repeller according to a first example of thei present invention is installed on a utility pole.

FIG. 2 is a rough state view of the bird repeller according to the first example of the present invention.

FIG. 3 is a rough perspective view showing a state in which a bird repeller according to a second example of the present invention is installed on a utility pole.

FIG. 4 is a roughly perspective state view and a cross-section view of the bird repeller according to the second

[Description of Reference Numerals]

| | | |
|---|---|---|
| 1: Utility Pole: | 2 Cross Arms | 21: Connecting Brackets |

| | |
|---|---|
| 100, 200: Bird Repeller | 110: Solar Cell |
| 120: Fixing Frame | 160: Noise Generator |
| 170: Sound Wave Generator | 180: LED Light Emitter |
| 190: Fixing Bracket | 210: Elastic Supporter |
| 211: Elastic Hanger | 220: Rotating Rod |
| 230: Rotating Wing | 240: Pinwheel |

### BEST MODE

Hereinbelow, preferred embodiments of the present invention will be described in detail with reference to the accompanying drawings. The embodiment of the present invention described hereinbelow is provided for allowing those skilled in the art to more clearly comprehend the present invention.

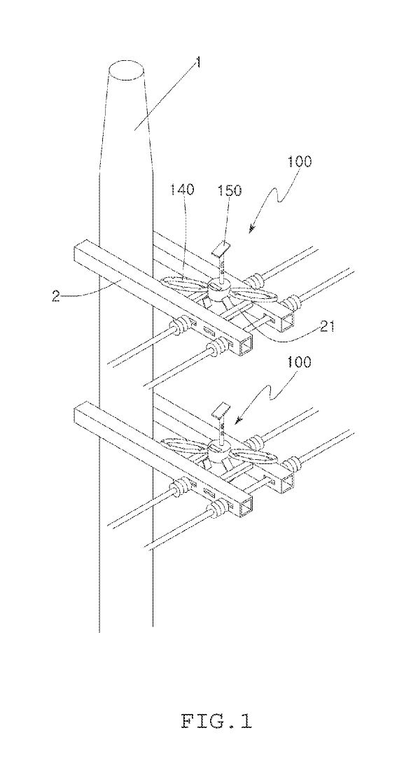

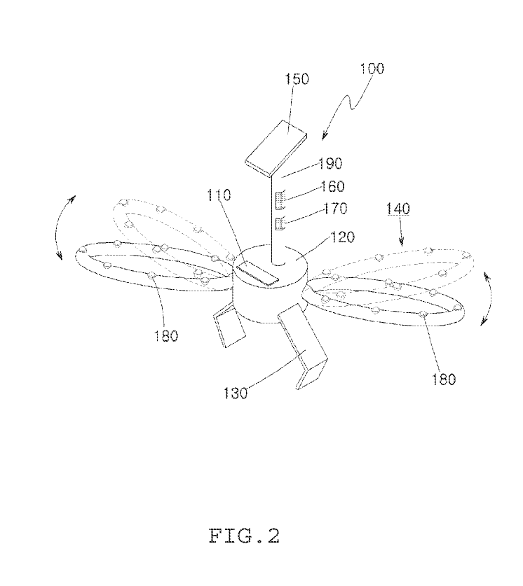

As illustrated in FIG. 1 and FIG. 2, a bird repeller 100 according to the present invention is fixedly installed in an upper side of cross arms 2 of a utility pole 1 to which high-tension lines are connected and installed.

The bird repeller includes: a solar cell 110 which converts solar light energy to electrical energy;

a fixing frame 120 which is adopted to fix and install the solar cell 110;

a flexible fixture 130 which is provided in a lower side of the fixing frame 120 and is elastically inserted and installed between the cross arms 2 so that it can be fixed;

a wing means 140 which is provided on both sides of the fixing frame 120 so as to flutter up and down, or right and left;

a bird detecting sensor 150 which is provided on an upper side of the fixing frame so as to recognize approach of the birds;

a noise generator 160 and a sound wave generator 170 which generate noises and sound waves which the birds dislike by operation of the birds detecting sensor 150; and

LED light emitters 180 which are connected to the solar cell and emit light which the birds dislike so as to prevent the birds from approaching.

Furthermore, the bird repeller 100 further includes a fixing bracket 190 which is provided on an upper side of the fixing frame 120 so that the bird detecting sensor 150, the noise generator 160, and the sound wave generator 170 can be installed.

Also, the LED light emitters 180 are connected to the solar cell 110, and have a structure in which the plurality of LED light emitters are installed on the wing means 140 at regular intervals and emit the light which the birds dislike in a certain cycle at the same time as the flapping of wings by the wing means 140.

Here, the LED light emitters 180 may be configured of a laser emitter which can emit laser light.

In addition, the wing means 140 is usually formed in an ellipse shape and has a space to an inner side thereof so that the resistance of air can be minimized when it flutters toward the air. However, the shape is not limited to the ellipse shape. Of course, it may be formed in other shapes. Also, the wing means 140 may be operated by the solar cell 110.

That is, an inner side end of the wing means 140 is connected and provided to a rotating means (not drawn) so that it can rotate up and down or right and left. The rotating means is configured so that a permanent magnet can perform a reciprocating motion in up and down directions or right and left directions by an electromagnet (not drawn) operated by the solar cell. Since the electromagnet is configured so that it pulls and pushes the permanent magnet, the reciprocating motion may be performed.

Since a reciprocating pendulum motion mechanism between the electromagnet and the permanent magnet may be formed by a publicly known technology in the relevant field, the detailed configurations and the description of a circuit are omitted.

Furthermore, the flexible fixture 130 has a central part formed as a type of tongs with a convex shape and is configured to be elastically inserted and installed between connecting brackets 21 installed in the cross arms 2.

As illustrated in FIG. 1, the bird repeller 100 according to the present invention which is configured as described above is easily installed in such a manner that when the flexible fixture 130 is elastically inserted between the connecting brackets 21 provided in the cross arms 2, its central part retracts. The bird repeller 10 installed in this manner prevents the approach of birds in such a way that the electromagnet and the permanent magnet are operated by the solar cell 100 which usually generates electricity from solar light, so the wing means 140 flutters at regular time intervals (5 to 10 minutes, and it is possible to adjust the time intervals).

Furthermore, when the wing means 140 flutters, the LED light emitters 180 provided thereto emit light which the birds dislike, thereby cutting off the approach of the birds with the flutters.

In addition, when the birds approach, the bird detecting sensor 150 detects them and operates. At the same time, various noises and sound waves which the birds dislike are generated from the noise generator 160 and the sound generator 170 so as to continuously prevent the birds from approaching, thereby preventing the birds from building their nests on an upper side of the cross arms of the utility pole, and preventing accidents such as a short-circuit in advance.

Also, as illustrated in FIG. 1, the bird repeller 100 may be installed in each cross arm even in a case in which the cross arms 2 are installed in more than two stages, i.e., multistages. Furthermore, the bird repeller 100 may be configured such that the respective bird repellers 100 are electrically connected to each other so that they are operated by one sensor.

In addition, the bird detecting sensor 150 may be configured in a structure in which a remote control function can be performed so that a worker can operate the bird detecting sensor 150 on the ground or during moving.

In this way, the bird repeller 100 may be en-oodied in various shapes by varying the configurations. Among them, the configurations of a second example are as follows.

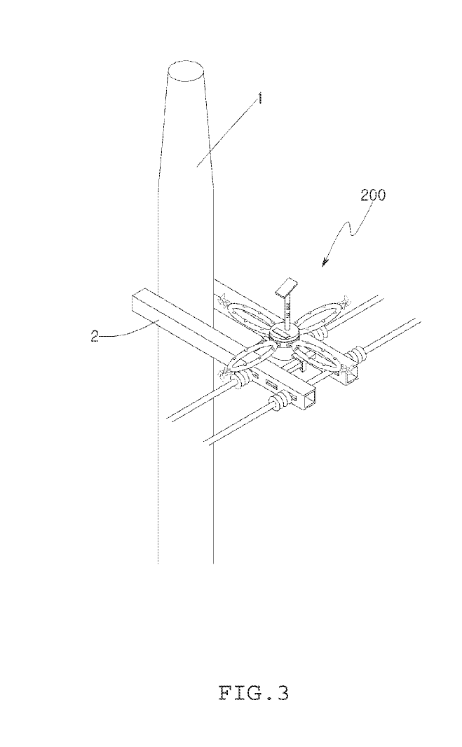

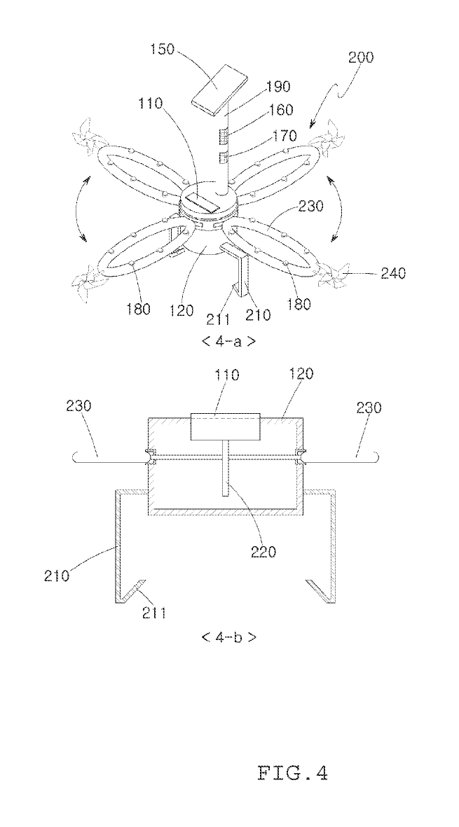

A bird repeller 200 according the second example of the present invention, as illustrated in FIG. 3 and FIG. 4, is fixedly installed on the upper side of the cross arms 2 of the utility pole 1 to which the high-tension lines are connected and installed.

The bird repeller includes: the solar cell 110 which converts solar light energy to electrical energy;

the fixing frame 120 which is adopted to fix and install the solar cell 110;

an elastic supporter 210 which is provided on both sides of the fixing frame 120 and is elastically inserted and installed between the cross arms 2 so that it can be fixed;

a rotating rod 220 which is provided to the fixing frame so that it can be rotated by the solar cell 110 from side to side in two directions;

a rotating wing 230 which is connected to the rotating rod 220 and rotates from side to side in two directions; and

a fixing bracket 190 which is installed on an upper part of the fixing frame 120, and in an end part which a bird detecting sensor 150 for detecting approaching of the birds, a noise generator 160 and a sound wave generator 170 operated by the bird detecting sensor 150 are installed.

The rotating wing 230 is configured such that the plurality of rotating wings are installed at regular intervals along a circumferential direction, and each pinwheel 250 rotated by the wind is installed and provided at end parts thereof. Furthermore, the rotating wing 230 has the LED light emitters 180 at regular intervals in a body thereof.

The elastic supporter 210 has an elastic hanger 211 which is formed on its end part in a hook shape and is elastically fixedly suspended on the connecting brackets 21 of the cross arms 2. Here, the elastic hanger 211 may be elastically suspended and fixed on the connecting bracket 21 of the cross arms 2 at the inside thereof or may be elastically suspended and fixed on the connecting bracket 21 of the cross arms 2 at the outside thereof.

The bird repeller 200 according to the second example of the present invention as described above, as illustrated in FIG. 3, is configured such that the rotating rod 220 is rotated by the solar cell 110 from side to side in two directions, and thus the rotating wing 230 is rotated.

Then, the pinwheel 240 provided on the rotating wing 230 is rotated, and the light is emitted from the LED light emitters 180 provided on the rotating wing 230, thereby preventing the birds from approaching.

Furthermore, when the birds approach, the bird detecting sensor 150 detects it and enables the noise generator 160 and the sound wave generator 170 to operate, so various noises and sound waves which the birds dislike are generated, thereby preventing the birds from approaching.

As described above, the bird repeller according to the present invention can efficiently prevent the birds from approaching and building their nests by the movement means using the principle of the permanent magnet and the electromagnet using the solar cell, and by generating noises, sound waves and emitting the light by the sensor for detecting the approach of the birds.

1. A bird repeller which is fixedly installed in cross arms (2) of a utility pole (1) to which high-tension lines are connected and installed, so as to prevent birds from approaching, the bird repeller comprising:
a solar cell (110) which converts solar light energy to electric power energy;
a fixing frame (120) which is adopted to fix and install the solar cell (110);
a flexible fixture (130) which is provided in a lower side of the fixing frame (120) and is elastically inserted and installed between the cross arms (2) so that it can be fixed;
a wing means (140) which is provided on both sides of the fixing frame (120) and is able to flutter up and down or right and left by the solar cell (110);
a bird detecting sensor (150) which is provided on an upper side of the fixing frame (120) and is able to recognize approach of the birds;
a noise generator (160) and a sound wave generator (170) which generate noises and sound waves which the birds dislike by operation of the bird detecting sensor (150); and
a plurality of LED light-emitters (180) which are connected to the solar cell (110) and emit light which the birds dislike so as to prevent the birds from approaching.

2. The bird repeller according to claim 1, further comprising: a fixing bracket (190) which is provided on the upper side of the fixing frame (120) so that the bird detectirig sensor (150), the noise generator (160), and the sound wave generator (170) can be installed.

3. The apparatus according to claim 2, wherein the flexible fixture (130) has a central part formed as a type of tongs with a convex shape and having elasticity.

4. A bird repeller which is fixedly installed in cross arms (2) of a utility pole (1), to which high-tension lines are connected and installed, so as to prevent birds from approaching, the apparatus comprising:
a solar cell (110) which converts solar light energy to electrical power energy;
a fixing frame (120) which is adopted to fix and install the solar cell (110);
an elastic supporter (210) which is provided on both sides of the fixing frame (120) and is elastically inserted and installed between the cross arms (2) so that it can be fixed;
a rotating rod (220) which is provided in the fixing frame (120) and is able to rotate from side to side in two directions by the solar cell (10);
a rotating wing (230) which is connected to the rotating rod (220) and rotates from side to side in two directions; and
a fixing bracket (190) which is installed on an upper part of the fixing frame (120), and in an end part of which a bird detecting sensor (150) for detecting approach of the birds, a noise generator (160) operated by the bird detecting sensor (150), and a sound wave generator (170) are installed.

5. The apparatus according to claim 4, further comprising: an elastic hanger which is provided in an end part of the elastic supporter (210) so that it can be elastically installed and fixed to connecting brackets (21) provided between the cross arms (2).
